(19) United States
(12) Patent Application Publication
(10) Pub. No.: US 2002/0191949 A1
(43) Pub. Date: Dec. 19, 2002

(54) Method and apparatus for recording and retrieving audio visual information

(76) Inventor: Alan M. Weatherford, Arroyo Grande, CA (US)

Correspondence Address: Sidney L. Weatherford, 1006 Rainbow Drive, Richardson, TX, 75081, US

(21) Appl. No.: 09/882,588

(22) Filed: Jun. 14, 2001

(51) Int. Cl. H04N 11/04; H04N 9/79

(52) U.S. Cl. 386/40

(57) ABSTRACT

A marker information storage and retrieval system, comprises a data input system that includes an input device for downloading digital audio and visual data and delivering power to a storage device. The storage device, i.e., a flash memory card, is provide for receiving and storing the digital audio and visual data and for storing the digital audio and visual data and for storing at least one executable program. The executable program is capable of retrieving and sending the stored data to a receiver or receiver/playback device. The receiver/playback device is capable of providing power to the storage device, storing the retrieved data and displaying the audio and visual data. A power source may be coupled to the receiver for powering the storage device and the receiver.

### BACKGROUND OF THE INVENTION

1. Technical Field

The present invention generally relates to information storage and delivery on demand of the stored information. More particularly, the present invention relates to storing information in a fixed location and delivering the stored information to a hand-held receiver. Still more particularly, the present invention relates to delivering audio and video data to a portable playback device.

2. Description of the Related Art

The recent progress of computer technology has been extraordinary. With respect to hardware, both speed of operation and memory capacity have been improved to remarkable levels. Especially in the field of memory media, early magnetic cores have been replaced by semiconductor integrated circuits, optico-magnetic storage devices, and flash memory devices that store both code and data in a single component without using special on-chip circuitry. The advances in software parallel those of the hardware in both speed and power.

Advances in the portability of computing devices such as the handheld Personal Digital Assistants (PDA) and hand-held Personal Computers (PC) coupled with the contemporaneous advances in data storage devices, including memory chips and other optical storage drives, flash memory cards, etc. have made it possible to store large amounts of data in ever smaller spaces. Similar advances in the devices required to extract the stored data have made possible the convenient and portable access of the data.

As a unit technology, it is already an established procedure to transform a large number of picture elements constituting a drawing, a photograph, document, or even movie into electrical signals, store them digitally as a package and give as output the reconstituted images. Such advances in software have made it possible for individual computing devices to display digitally recorded pictures, movies and audio recordings such as speeches or music. Additionally, the handheld devices can even access radio broadcasts, both recorded and live transmission, over a network.

A marker information storage and delivery device adapted to store video and/or audio information recorded for the enlightenment of interested parties is relatively common. The stored information usually relates to a marker or monument of some sort. In the case of markers for deceased persons such as headstones or grave markers, the interested parties might logically be relatives, admirers, or simply inquisitive persons. In the case of historical markers or other attractions of general interest, the interested parties could include tourists or afficionados of the subject matter.

Typically, the stored information is on magnetic media, such as audio or video tape or a CD-ROM or similar media. The storage device is powered either by AC power or battery power. The disadvantage to AC power is that the location of the storage device is restricted to locations that are serviced by AC power. A battery powered storage device, though independent of location must be constantly checked to assure that the battery power is adequate to power the storage device so that an interested party may retrieve data.

Therefore, there is a need for a storage and retrieval system that is capable of providing audio and visual recordings (data) data without the need for permanently connected on-site power.

### SUMMARY OF THE INVENTION

It is thus, an object of the invention to provide a system and method which records, stores and subsequently delivers information, through a portable or handheld playback device.

It is a further object of the invention to provide a system and method to retrieve audio and visual data from a storage source wherein the storage source is not connected to a power source.

The marker information storage and retrieval system, according to the present invention, comprises a data input system which includes 1) an input device for downloading digital audio and visual data; 2) a storage device for receiving the digital audio and visual data and for storing at least one executable program that is capable of retrieving and transmitting the stored data to a receiver; 3) a receiver for receiving the audio and visual data from the input device; and 4) a power source coupled to the receiver for powering the storage device and the receiver.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a high-level block diagram of a system for the marker information storage device and the information retrieval device in accordance with the present invention; and

FIG. 2 is a high-level flow diagram of a method for recording and retrieving audio/visual information in accordance with a preferred embodiment of the present invention.

### DETAILED DESCRIPTION OF THE PREFERRED EMBODIMENT

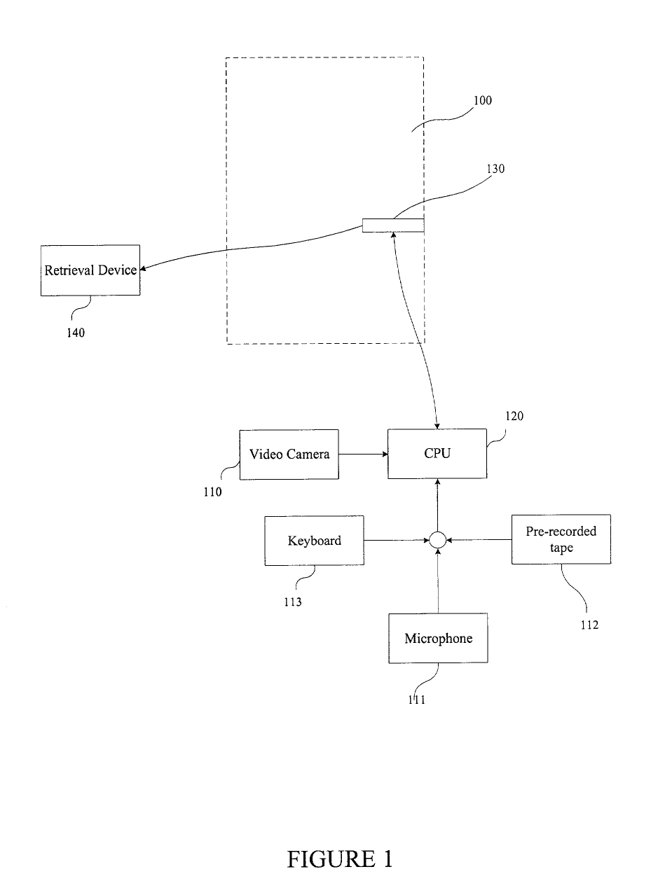

With reference now to the figures, and in particular with reference to FIG. 1, a high-level block diagram of the marker information storage and retrieval system according to an exemplary embodiment of the present invention is illustrated. The device of the present invention comprises marker data input system 110-113, processing device 120, marker information storage system 130, and information retrieval system 140. Marker information storage system 130 is shown installed in marker 100.

The marker data input system 110-113 includes: a means of recording both still and motion visuals, with or without sound, a means of recording sound, and a means of recording a computer generated slide show/presentation which may or may not include sounds and/or visuals. Marker data input system 110-113 is adapted to receive marker information consisting of still picture data and/or sound data as well as data in written or text form. Marker data input system 110-113 includes video camera 110, either digital or analog, and the sound recording means is microphone 111 that is coupled to and coordinated with video camera 110.

The visual recording means mentioned above may comprise a video camera or digital camera (still camera), a monitor for simultaneous display of video data from camera 110 and a frame memory (not shown) for selecting an image from camera 110 and storing it as a still picture. The sound pickup means may comprise microphone 111 and a pulse code modulation (PCM) converter (not shown) for converting sound from microphone 110 to digital signals. In any case, it may be so arranged that the person who wishes to store recorded images and sounds as marker information (also termed marker data) may optionally elect to store the information in the form of a number of different combinations of still or motion pictures and/or sound data files as well as text data files.

The information is recorded by marker data input system 110-113 and may be transferred to processing device 120 where information, in the form of digital data, is organized and stored in an acceptable, retrievable form. Processing device 120 may be a handheld computer, a personal digital assistant (PDA) or any device that is capable of audio and/or audio/video playback functions. Generally, processing device utilizes a harness with special weatherproof, quick connect connectors for connecting to marker storage device 130. In another embodiment, processing device 120 may transfer data to and from marker storage device 130 by radio signals. Power may be provided by processing device 120 utilizing either an electrical harness or by broadcast power transmission, such as microwave energy.

Information to be stored in marker storage device 130 may take the form of a short movie with or without an audio track. Another form that the stored information may take is that of an audio recording. This audio recording may be combined with a stored slide show presentation, that would be simultaneously uploaded to retrieval device 140. Further, the slide show presentation may be uploaded and played without the aid of audio.

Video camera 110 may be utilized to capture a picture image (still) or a dynamic series of picture images (full or partial motion) transforming the shades and hues of minute areas of the image into the corresponding electrical signals and then output the signals to the next stage, processing unit 120. Sound data collected by microphone 111 will also be transmitted to processing unit 120 as sound data in the form of electrical signals.

The retrievable information produced by processor 120 is transferred in digital format, typically, via a connecting wire harness or transmitted by radio waves, into information storage device 130. Information storage device 130 may comprise a flash memory, a solid state disk drive, a small form factor hard disk drive or any device that is capable of storing data from marker storage device 130. The stored data is then retrievable by interested parties utilizing retrieval device 140 which may be a personal digital assistant (PDA), a handheld computer, or other portable device capable of displaying and/or storing the retrieved information.

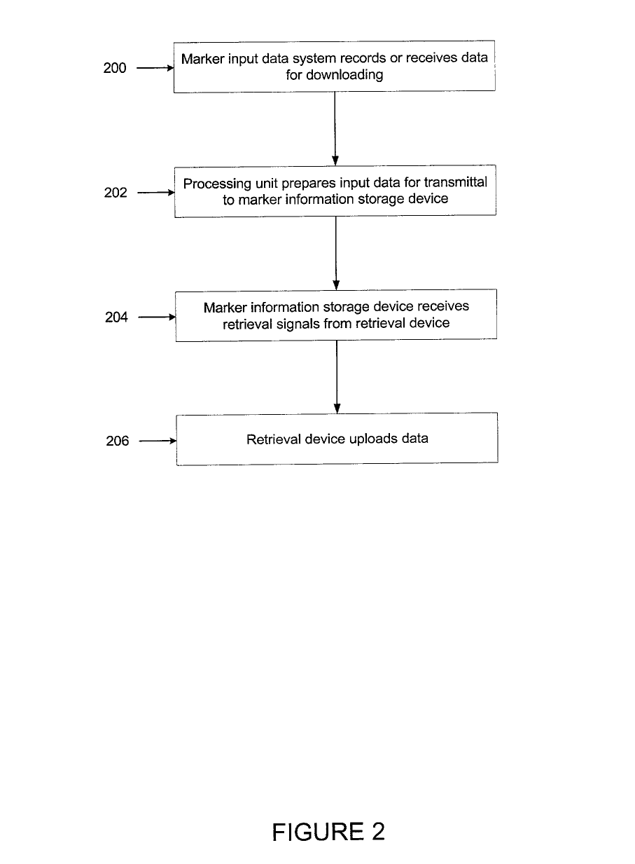

FIG. 2 is a high-level flow diagram of a method for recording and retrieving audio/visual information in accordance with a preferred embodiment of the present invention. The process begins with marker data input system 110-113 recording or transferring data to processing device 120 (process step 200). Marker data input system 110-113 may be adapted to receive marker data that consists of picture data and/or sound data as well as data in written or text form. The marker data input system 110-113 includes a camera 110 (video camcorder, digital still camera, etc.), a microphone 111, a computer scanner (not shown), tape recorder and playback system (not shown), or computer keyboard 113. Camera 112 captures a still picture or a dynamic series of picture images (full or partial motion) transforming the shades and hues of minute areas of the image into the corresponding electrical signals. The electrical signals that define the image(s) are then output to the next stage, processing device 120. Sound collected by microphone 111 will also be transmitted to processing device 120 as sound data (process step 202).

The electrical signals are stored as one or more data files on processing device 120 volatile memory or stored on processing device 120 storage component (not shown) to await processing. In processing the marker data, the conversion of analog data to digital data is a standard operation but such conversion is not absolutely necessary. The stored data file will subsequently be loaded into a program that will process the image and add it to other images, sounds or text to form a completed file (process step 204).

A completed file, as described above, is then transferred to the marker information storage device 130 where it will remain. This last file is ready to be accessed by an interested party by way of a marker information retrieval system 140 (process step 206).

The information storage unit 130 in this embodiment comprises a flash memory card and a flash memory card reader, which are known in the art. Flash memory cards range in size from 8 megabytes to 1 gigabyte or more of storage capacity. The flash memory card will remain inserted in the flash memory card reader. The memory card and reader will be permanently installed in, on, or near the marker. The flash memory card reader needs no power supply as the marker data storage device will draw the power required for operation from the retrieval device when connected for data transfer.

Information retrieval device 140 accesses marker data storage device 110 and effects an upload of a file from marker data storage device 110. The retrieved file is then displayed in visually and/or audibly recognizable form on retrieval device 140. Alternatively, the retrieved file can be stored by the retrieval device for replay at a later time.

The purpose of the present invention is to provide information about the subject of a marker. For instance, the marker may be that which commemorates an event that took place at some location. Presently, there is a severe limit to the amount of information that can be supplied at the site. That limit is usually dictated by the size of the plaque or monument placed at the site. There may be other forms of information in nearby gift shops, but the permanent plaques prescribe the amount of information available to interested parties. The present invention will allow a large amount of information to be passed along to interested people at the site.

A person with an interest in architecture may take a walking tour of a city, plugging a connecting cable from retrieval device 140 into the marker data storage devices 130 at the sites of buildings of interest. The information retrieved may run the gamut from a pictorial review of the building's construction to a slide show presentation with accompanying narrative from the architect and/or other parties linked to the site.

Another use of the invention is as an accessory to a headstone or other memorial marker or monument for a deceased person. At present, when one views the burial or entombment site of a person the information is quite limited. Often the information is limited to name, date of birth, date of death, and occasionally places of birth and death as well. This information is quite literally written in stone. Very little about the subject's life can be learned from the headstone. Such is not the case with the present invention. This invention will allow the family of the deceased to record it relevant information about the deceased's life. The relevant information can be in text, audio or even visual format. Film clips of the subject when alive, or perhaps at several times during the subject's life can be retrieved for viewing. Sound recordings of the subject speaking or singing could be available as well. In fact, if sufficient time were available prior to the subject's death, the subject could decide what message was to be left for those who followed.

The ability to store on site so much history will make genealogical searches much more fruitful. No longer will people look at the headstone and wonder what the person did when alive, what kind of work did that person do, who were relations of this individual, etc. The questions that occur to us as we view the memorial of someone with whom we are not familiar can now be answered.

While the invention has been particularly shown and described with reference to a preferred embodiment, it will be understood by those skilled in the art that various changes in form and detail may be made therein without departing from the spirit and scope of the invention.

What is claimed is:

1. An system for recording, storing and retrieving audio/visual data, comprising:
a storage device capable of receiving and storing said audio/visual data, comprising:
a memory coupled to a receiving circuit for respectively receiving and storing said audio/visual data;
a transmitting circuit coupled to said memory for transmitting said stored audio/visual data; and
a playback device capable of activating and powering said storage device wherein said audio/visual data is sent to said playback device for playback.

2. The system of claim 1, further comprising a processing device for transferring data files to said storage device and wherein said processing device is capable of powering said storage device.

3. The system of claim 1, wherein said playback device further comprises:
a memory for temporarily storing pre-recorded said audio/visual data; and
a controller for transmitting said pre-recorded data to said storage device.

4. The apparatus as set forth in claim 1 further comprising:
a first connector for electrically connecting a first end of a cable harness to said storage device; and
a second connector for electrically connecting a second end of said cable harness to said playback device.

5. The system as set forth in claim 3, wherein said first connector contains a power cable for powering said storage device.

6. The system as set forth in claim 4, wherein said storage device is provided with a weatherproof connector for connecting to said first connector of said cable harness.

7. The system as set forth in claim 1, wherein said playback device is capable of supplying power through said power cable to said storage device.

8. The apparatus as set forth in claim 1, wherein said playback device is capable of receiving and displaying said audio/visual data.

9. A method for recording, storing and retrieving audio/visual information, comprising the steps of:
temporarily coupling a processing device to a storage device for sending at least one predetermined data file to said storage device, wherein said processing device provides power to said storage device via said connecting cable;
storing said at least one predetermined data file on said storage device for retrieval; and
providing an executable program to operate said storage device for receiving and sending data files.

10. The method of claim 9 further comprising the steps of:
temporarily coupling a retrieval device for uploading said at least one predetermined data file, wherein said coupling step is accomplished by one of a wiring harness means and a wireless transmission means;
providing power to said storage device; and
activating said executable program to cause said storage device to send said at least one predetermined data file to said retrieval device.

11. The method of claim 9, further comprising the step of sending said at least one predetermined data file to said retrieval device.

12. The method of claim 9, wherein said executable program for operating said storage device is stored on said storage device.

13. The method of claim 9, wherein said executable program for operating said storage device is stored on said playback device.

14. The method of claim 9, wherein said power is supplied to said storage device by wireless means.
